(19) United States
(12) Patent Application Publication
(10) Pub. No.: US 2006/0244255 A1
(43) Pub. Date: Nov. 2, 2006

(54) Female plumbing connection

(76) Inventor: Gabe Coscarella, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/408,914

(22) Filed: Apr. 21, 2006

(30) Foreign Application Priority Data
Apr. 27, 2005 (CA) 2,505,621

(51) Int. Cl. F16L 41/00

(52) U.S. Cl. 285/189

(57) ABSTRACT

A female plumbing connection, which includes a body having an exterior. An interior side wall extends to the exterior to define a female receptacle, which is both accessible from the exterior and adapted to receive, in mating relation, an end of a plumbing pipe. A shoulder protrudes radially inwardly from the interior side wall. The shoulder is spaced from the exterior and has a remote edge, remote from the interior side wall. An upstanding rim extends upwardly from the remote edge of the shoulder. The shoulder with upstanding rim creates a barrier preventing adhesive used to secure the end of the plumbing pipe within the female receptacle from passing by force of gravity along the interior side wall.

### FIELD OF THE INVENTION

The present invention relates to a female plumbing connection, which is intended to mate with a plumbing pipe and be secured in mating relation with adhesive.

### BACKGROUND OF THE INVENTION

An increasing number of plumbing installations use polymer plastic plumbing pipe. The pipe is secured in mating relation to female plumbing connections by means of adhesive.

### SUMMARY OF THE INVENTION

According to the present invention there is provided a female plumbing connection, which includes a body having an exterior. An interior side wall extends to the exterior to define a female receptacle, which is both accessible from the exterior and adapted to receive, in mating relation, an end of a plumbing pipe. A shoulder protrudes radially inwardly from the interior side wall. The shoulder is spaced from the exterior and has a remote edge remote from the interior side wall. An upstanding rim extends upwardly from the remote edge of the shoulder. The shoulder with upstanding rim creates a barrier preventing adhesive used to secure the end of the plumbing pipe within the female receptacle from passing by force of gravity along the interior side wall.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a plumbing fitting having a female plumbing connection in accordance with the teachings of the present invention.

FIG. 2 is a side elevation view, in section, of the plumbing fitting illustrated in FIG. 1, secured by adhesive to an end of a plumbing pipe.

### DETAILED DESCRIPTION OF THE PREFERRED EMBODIMENT

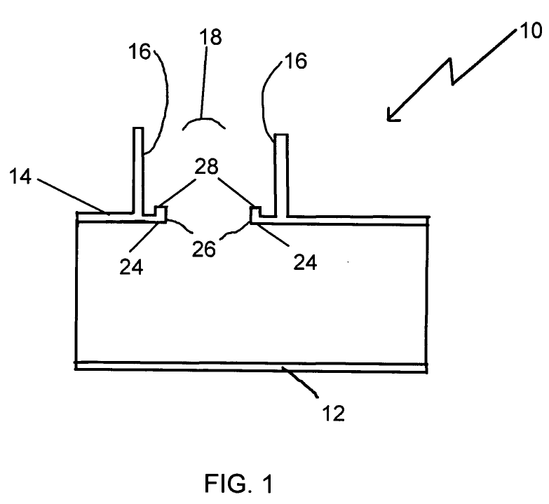

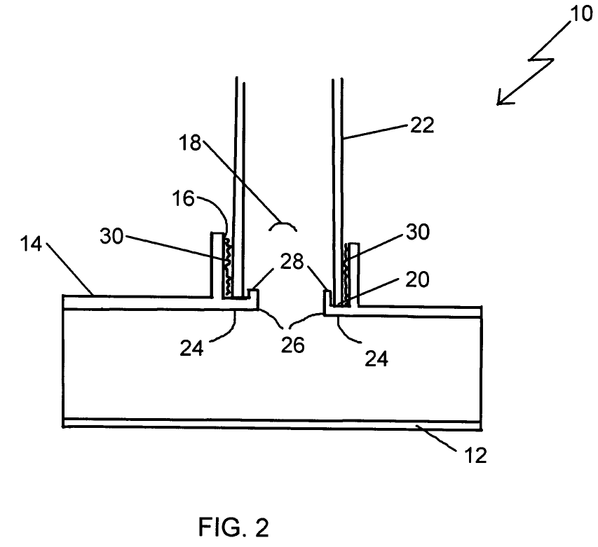

The preferred embodiment, a female plumbing connection generally identified by reference numeral 10, will now be described with reference to FIGS. 1 and 2.

Structure and Relationship of Parts:

Referring to FIG. 1, female plumbing connection 10 includes a body 12. The body chosen for illustration purposes is that of a plumbing fitting, it will be understood that the same principles can be applied to different types of bodies used in plumbing. Body 12 has an exterior 14. An interior side wall 16 extends to exterior 14 to define a female receptacle, generally indicated by reference numeral 18. Female receptacle 18 is accessible from exterior 14. Referring to FIG. 2, female receptacle 18 is adapted to receive, in mating relation, an end 20 of a plumbing pipe 22. Referring to FIG. 1, a shoulder 24 protrudes radially inwardly from interior side wall 16. Referring to FIG. 2, shoulder 24 is spaced from exterior 14 by a distance sufficient to make connection with end 20 of plumbing pipe 22. Referring to FIG. 1, shoulder 24 has a remote edge 26 remote from interior side wall 16. An upstanding rim 28 extends upwardly from remote edge 26 of shoulder 24.

Operation:

The use and operation of female plumbing connection 10 will now be described with reference to FIG. 1 and FIG. 2. Referring to FIG. 2, in the course of completing a plumbing installation, end 20 of plumbing pipe 22 is secured within female receptacle 18 by a coating of adhesive 30, which forms an adhesive bond between interior side wall 16 and plumbing pipe 22. In the prior art, adhesive 30 could and often did run past end 20 of plumbing pipe 22. With female plumbing connection 10, shoulder 24 with upstanding rim 28 creates a barrier preventing adhesive 30 used to secure end 20 of plumbing pipe 22 within female receptacle 18 from passing by force of gravity farther along interior side wall 16.

It will be apparent to one skilled in the art that modifications may be made to the illustrated embodiment without departing from the spirit and scope of the invention as hereinafter defined in the Claims.

What is claimed is:

1. A female plumbing connection, comprising:
a body having an exterior and an interior side wall that extends to the exterior to define a female receptacle which is both accessible from the exterior and adapted to receive, in mating relation, an end of a plumbing pipe;
a shoulder protruding radially inwardly from the interior side wall, the shoulder being spaced from the exterior, the shoulder having a remote edge, remote from the interior side wall;
an upstanding rim extending upwardly from the remote edge of the shoulder, such that the shoulder with upstanding rim create a barrier preventing adhesive used to secure the end of the plumbing pipe within the female receptacle from passing by force of gravity along the interior side wall.

2. The female plumbing connection as defined in claim 1, wherein the body is a plumbing fitting.
